(19) United States
(12) Patent Application Publication
(10) Pub. No.: US 2026/0120899 A1
(43) Pub. Date: Apr. 30, 2026

(54) PULSED FLOW REGULATING DEVICE WITHOUT ROTATING PARTS AND COOLING STRUCTURE FOR NUCLEAR POWER PLANT REACTOR

(71) Applicant: SHANGHAI JIAO TONG UNIVERSITY, Shanghai (CN)

(72) Inventor: Po HU, Shanghai (CN)

(21) Appl. No.: 19/407,115

(22) Filed: Dec. 3, 2025

Related U.S. Application Data
(63) Continuation of application No. PCT/CN2023/110672, filed on Aug. 2, 2023.

(30) Foreign Application Priority Data
Jun. 12, 2023 (CN) 202310694342.7

(51) Int. Cl. G21C 19/04; G21C 15/14

(52) U.S. Cl. CPC G21C 19/04; G21C 15/14

(57) ABSTRACT

A pulsed flow regulating device without rotating parts, including a water holding container, a water outlet channel and a first water inlet. The regulating device is configured to apply a pulsed flow onto the to-be-cooled wall surface for cooling. External cooling water enters the water holding container through the first water inlet. The water outlet channel has an inverted U-shaped structure, and has a water outlet and a second water inlet. The second water inlet is located within the water holding container. The water outlet extends through a bottom of the water holding container to guide water flow onto the to-be-cooled wall surface. A cross-sectional area of the water holding container is greater than that of the water outlet channel. A cooling structure for a nuclear power plant reactor is also provided.

### CROSS-REFERENCE TO RELATED APPLICATIONS

This application is a continuation of International Patent Application No. PCT/CN2023/110672, filed on Aug. 2, 2023, which claims the benefit of priority from Chinese Patent Application No. 202310694342.7, filed on Jun. 12, 2023. The content of the aforementioned application, including any intervening amendments thereto, is incorporated herein by reference in its entirety.

### TECHNICAL FIELD

This application relates to water flow cooling, and more particularly to a pulsed flow regulating device without rotating parts, and a cooling structure for a nuclear power plant reactor.

### BACKGROUND

In a pressurized water reactor nuclear power plant, when a loss-of-coolant accident or a main steam line break occurs inside the containment, the water vapor content within the inner containment rises rapidly, leading to a substantial increase in internal pressure and temperature. Once the pressure and temperature reach the set value at which an isolation valve at a bottom of a cooling water storage tank opens, cooling water flows out from the cooling water storage tank located at a top of the containment under gravity, passes through a water film distribution device, and forms an evenly distributed falling water film flow on an outer wall surface of the containment. A velocity of the water film is controlled by a liquid level of the cooling water storage tank. As the water film flows downward along the outer wall surface of the containment, significant evaporative heat transfer occurs at a surface of the water film due to convection with the surrounding airflow. Meanwhile, a temperature of the water film continuously increases along a flow direction, resulting in single-phase convective heat transfer. These two dominant heat transfer mechanisms collectively remove the accumulated heat inside the containment, thereby maintaining the temperature and pressure at safe levels.

Since the evaporative heat transfer efficiency of the water film is stronger than its single-phase convective heat transfer efficiency, under the same heat transfer requirement, increasing a proportion of evaporative heat transfer of the water film in the total heat transfer will effectively reduce a total required water film flow rate and decrease a volume of the cooling water storage tank. Therefore, there is an urgent need to design a flow regulating device capable of enhancing the proportion of evaporative heat transfer of the water film.

### SUMMARY

An object of the disclosure is to provide a pulsed flow regulating device without rotating parts and a cooling structure for a nuclear power plant reactor to overcome the defects in the prior art.

Technical solutions of the present disclosure are described as follows.

In a first aspect, this application provides a pulsed flow regulating device without rotating parts, the pulsed flow regulating device being configured to apply a pulsed flow to a to-be-cooled wall surface for cooling, and the pulsed flow regulating device comprising:
a water holding container;
a water outlet channel; and
a first water inlet;
wherein cooling water is configured to be supplied by an external source to enter the water holding container through the first water inlet;
the water outlet channel has a water outlet and a second water inlet;
the second water inlet is located within the water holding container;
the water outlet of the water outlet channel is configured to extend through a bottom of the water holding container to guide water flow to the to-be-cooled wall surface; and
a cross-sectional area of the water holding container is greater than a cross-sectional area of the water outlet channel.

In some embodiments, the water outlet channel has an inverted U-shaped structure; and the water outlet and the second water inlet are respectively located at two ends of the water outlet channel.

In some embodiments, a top of the water holding container, an arc-shaped top of the water outlet channel, the second water inlet and the water outlet are arranged sequentially from high to low.

In some embodiments, a water flow rate at the first water inlet is less than a water flow rate in the water outlet channel.

In some embodiments, the number of the water outlet channel is one; and a cross-sectional area of the first water inlet is smaller than the cross-sectional area of the water outlet channel.

In some embodiments, a plurality of water outlet channels are provided; and a cross-sectional area of the first water inlet is smaller than a sum of cross-sectional areas of the plurality of water outlet channels.

In some embodiments, the pulsed flow regulating device further comprises a cooling water storage tank;
wherein the cooling water storage tank is configured to hold cooling water; and the cooling water is configured to enter the water holding container through the first water inlet.

In a second aspect, this application provides a cooling structure for a nuclear power plant reactor, comprising:
the pulsed flow regulating device described above.

### BRIEF DESCRIPTION OF THE DRAWINGS

Other features, objects and advantages of the present disclosure will become apparent from the following detailed description of embodiments with reference to the accompanying drawings.

FIG. 1 schematically shows a pulsed flow regulating device without rotating parts according to an embodiment of the present disclosure; and FIG. 2 schematically shows an operating principle of the pulsed flow regulating device according to an embodiment of the present disclosure.

In the figures: 1—water holding container; 2—water outlet; 3—water outlet channel; 4—second water inlet; 5—first water inlet; and 6—arc-shaped top.

### DETAILED DESCRIPTION OF EMBODIMENTS

The present disclosure is described in detail below in conjunction with the embodiments. The following embodiments are provided to assist those skilled in the art in further understanding the present disclosure and are not intended to limit the scope of the disclosure. It should be noted that various changes and modifications made by those of ordinary skill in the art without departing from the spirit of the disclosure shall fall within the scope of the present disclosure defined by the appended claims.

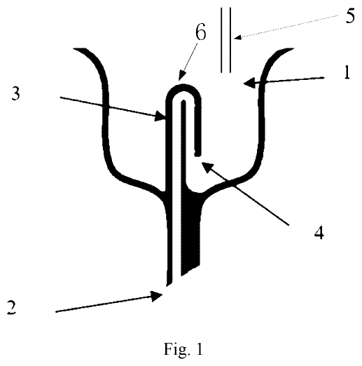

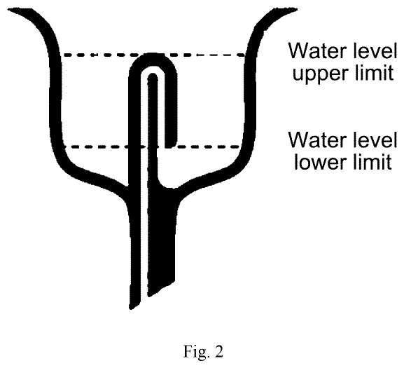

An embodiment of the present disclosure provides a pulsed flow regulating device without rotating parts. As shown in FIG. 1, the pulsed flow regulating device is configured to apply a pulsed flow to a high-temperature to-be-cooled wall surface for cooling.

The pulsed flow regulating device includes a water holding container 1, a water outlet channel 3 and a first water inlet 5. The water outlet channel 3 has a water outlet 2 and a second water inlet 4. The second water inlet 4 is located within the water holding container 1. The water outlet 2 of the water outlet channel 3 is configured to extend through a bottom of the water holding container 1 to guide water flow to the to-be-cooled wall surface. A cross-sectional area of the water holding container 1 is greater than a cross-sectional area of the water outlet channel 3. In an embodiment, the first water inlet 5 may be a pipeline structure with or without a valve. The first water inlet 5 is located above the water holding container 1, or is communicated with the water holding container 1 through an opening formed in a side wall of the water holding container 1.

The water outlet channel 3 has an inverted U-shaped structure. The water outlet 2 and the second water inlet 4 are respectively located at two ends of the water outlet channel 3. A top of the water holding container 1, an arc-shaped top 6 of the water outlet channel 3, the second water inlet 4 and the water outlet 2 are arranged sequentially from high to low.

A water flow rate at the first water inlet 5 is less than a water flow rate in the water outlet channel 3. In an embodiment, the number of the water outlet channel 3 is one. A cross-sectional area of the first water inlet 5 is smaller than the cross-sectional area of the water outlet channel 3. In an embodiment, a plurality of water outlet channels 3 are provided. A cross-sectional area of the first water inlet 5 is smaller than a sum of cross-sectional areas of the plurality of water outlet channels 3.

In an embodiment, the pulsed flow regulating device further includes a cooling water storage tank. The cooling water storage tank is configured to hold cooling water. The cooling water is configured to enter the water holding container 1 through the first water inlet 5.

The operating principle of the pulsed flow regulating device is as follows.

When water is continuously supplied from upstream into the water holding container 1, a water level in the water holding container 1 rises from the bottom of the water holding container 1. When the water level reaches the second water inlet 4, water also gradually enters the inverted U-shaped channel near the second water inlet 4. The water level in the inverted U-shaped channel becomes equal to that in the water holding container 1. However, since the liquid surface pressure inside the inverted U-shaped channel and that in the water holding container 1 are both at atmospheric pressure, the pressures are balanced, and no water flows out from the water outlet 2.

As shown in FIG. 2, when the water level continues to rise and exceeds the arc-shaped top 6 of the inverted U-shaped channel (water level upper limit, above which water begins to flow from the water outlet 2), the water level in the water holding container 1 is higher than that in the inverted U-shaped water outlet channel 3. The resulting pressure difference drives water in the water outlet channel 3 to flow out from the water outlet 2. Moreover, since the cross-sectional area of the water holding container 1 is larger than that of the inverted U-shaped channel (i.e., the water outlet channel 3), the liquid level in the water holding container 1 decreases more slowly than that in the inverted U-shaped channel, thereby maintaining the water level difference, i.e., the pressure difference, ensuring a continuous water flow from the water outlet 2. At the same time, because a flow rate of the upstream continuous water supply is less than a flow rate at the water outlet 2 (i.e., a liquid flow rate at the first water inlet 5 is less than a water flow rate in the water outlet channel 3), the water level in the water holding container 1 continues to decrease even with uninterrupted upstream water supply.

Until the water level in the water holding container 1 reaches the second water inlet 4 of the inverted U-shaped water outlet channel (water level lower limit, below which the water flow at the water outlet 2 is cut off), no more water can enter the inverted U-shaped channel, and the water flow from the water outlet 2 stops.

Meanwhile, since the upstream water supply at the first water inlet 5 continues uninterrupted, when the water flow at the water outlet 2 is cut off, the water level in the water holding container 1 begins to rise again, thereby repeating the above process.

In summary, the present disclosure achieves a pulsed flow by relying on pressure differences generated from changes in the water level, without any rotating parts. This design is simpler and more reliable, forming a pulsed flow that sprinkles onto high-temperature wall surfaces. This can increase the proportion of heat transfer achieved by water film evaporation, and under the same heat transfer requirements, effectively reduce the total water film flow needed and decrease the volume of the cooling water storage tank.

As used herein, the orientation or position relationship indicated by terms such as “up”, “down”, “front”, “back”, “left”, “right”, “vertical”, “horizontal”, “top”, “bottom”, “inner” and “outer” is based on the those shown in the accompanying drawings. These terms are solely for the convenience of describing the present disclosure, and are not intended to indicate or imply that the devices or components must have specific orientations or be constructed and operated in specific orientations. Therefore, these terms should not be understood as limitations of the present disclosure.

Compared to the prior art, the present disclosure has the following beneficial effects.

1. The present disclosure provides a pulsed water-cooling method, which can increase the proportion of total heat transfer contributed by water film evaporation and, under the same heat transfer requirements, effectively reduce the total water film flow needed and decrease the volume of the cooling water storage tank.

2. The present disclosure utilizes the siphon principle and the variation of the water level in the water holding container 1 to convert a continuous flow into a pulsed flow. When the water film flow is zero, the surface temperature of the to-be-cooled wall temporarily rises. Subsequently, the flowing water removes the heat, and then the water flow stops, repeating this cycle. Under this mode, the higher wall surface temperature raises the water film temperature, resulting in an increased water film evaporation rate and thereby increasing the proportion of total heat transfer contributed by water film evaporation. As a result, under the same heat transfer requirements, the total water film flow needed can be effectively reduced, the volume of the cooling water storage tank decreased, and the structure remains reliable and easy to implement.

3. The present disclosure achieves a pulsed flow without the need for external power or rotating parts. The structure is simple, reliable, and energy-efficient, making it environmentally friendly.

The above describes the embodiments of the present disclosure. It should be understood that the present disclosure is not limited to the embodiments described above. Various modifications or variations may be made by those skilled in the art within the scope of the claims without departing from the spirit of the present disclosure. In the absence of contradiction, features disclosed in different embodiments may be freely combined.

What is claimed is:

1. A pulsed flow regulating device without rotating parts, the pulsed flow regulating device being configured to apply a pulsed flow to a to-be-cooled wall surface for cooling, and the pulsed flow regulating device comprising:
a water holding container;
a water outlet channel; and
a first water inlet;
wherein cooling water is configured to be supplied by an external source to enter the water holding container through the first water inlet;
the water outlet channel has a water outlet and a second water inlet; the second water inlet is located within the water holding container; the water outlet of the water outlet channel is configured to extend through a bottom of the water holding container to guide water flow to the to-be-cooled wall surface; and
a cross-sectional area of the water holding container is greater than a cross-sectional area of the water outlet channel.

2. The pulsed flow regulating device of claim 1, wherein the water outlet channel has an inverted U-shaped structure; and the water outlet and the second water inlet are respectively located at two ends of the water outlet channel.

3. The pulsed flow regulating device of claim 2, wherein a top of the water holding container, an arc-shaped top of the water outlet channel, the second water inlet and the water outlet are arranged sequentially from high to low.

4. The pulsed flow regulating device of claim 1, wherein a water flow rate at the first water inlet is less than a water flow rate in the water outlet channel.

5. The pulsed flow regulating device of claim 1, wherein the number of the water outlet channel is one; and a cross-sectional area of the first water inlet is smaller than the cross-sectional area of the water outlet channel.

6. The pulsed flow regulating device of claim 1, wherein a plurality of water outlet channels are provided; and a cross-sectional area of the first water inlet is smaller than a sum of cross-sectional areas of the plurality of water outlet channels.

7. The pulsed flow regulating device of claim 1, further comprising:
a cooling water storage tank;
wherein the cooling water storage tank is configured to hold cooling water; and the cooling water is configured to enter the water holding container through the first water inlet.

8. A cooling structure for a nuclear power plant reactor, comprising:
the pulsed flow regulating device of claim 1.
